(19) United States
(12) Patent Application Publication
(10) Pub. No.: US 2019/0230478 A1
(43) Pub. Date: Jul. 25, 2019

(54) REAL TIME TRACKING AND POSITIONING SYSTEM

(71) Applicant: Indiana University Research and Technology Corporation, Indianapolis, IN (US)

(72) Inventors: Kylie Aine Peppler, Bloomington, IN (US); Joshua A. Danish, Bloomington, IN (US); Shenshen Han, Bloomington, IN (US)

(21) Appl. No.: 16/369,928

(22) Filed: Mar. 29, 2019

Related U.S. Application Data
(63) Continuation-in-part of application No. PCT/US2017/054508, filed on Sep. 29, 2017.
(60) Provisional application No. 62/401,819, filed on Sep. 29, 2016.

(51) Int. Cl. H04W 4/029; H04W 24/08; G01S 13/87; G01S 13/72

(52) U.S. Cl. CPC H04W 4/029; H04W 24/08; G06F 3/14; G01S 13/72; G01S 13/878

(57) ABSTRACT

A real time tracking and positioning system comprising at least four anchors, at least one actor configured to interact with the at least four anchors, and an electronic device in communication with at least one of the at least four anchors, the electronic device being configured to receive two-way ranging/distance data for each actor and calculate a real-time position of each actor based on the two-way ranging/distance data, the two-way ranging/distance data including a round-trip time of a radio frequency signal between the at least one actor and each of the at least four anchors.

### CROSS-REFERENCE TO RELATED APPLICATIONS

The present application is a continuation-in-part of PCT Application No. PCT/US2017/054508, filed Sep. 29, 2017, which claims priority to U.S. Provisional Application No. 62/401,819, filed Sep. 29, 2016, the entire disclosures of which being hereby expressly incorporated herein by reference.

### STATEMENT REGARDING FEDERALLY SPONSORED RESEARCH OR DEVELOPMENT

This invention was made with government support under 1324047 awarded by the National Science Foundation. The government has certain rights in the invention.

### FIELD OF DISCLOSURE

The present disclosure relates generally to a real time tracking and positioning system, and, more particularly, to a real time tracking and positioning system capable of detecting accurate positions of actors in real-time.

### BACKGROUND OF DISCLOSURE

Position tracking has become more important as technologies have developed over the years. For instance, it has been established that position tracking could be a very useful tool for educational and playful engagement purposes as well as other various activities or purposes where location is important and/or helpful (i.e., personnel and/or equipment tracking). However, known physical position systems either work poorly indoors or lack sufficient accuracy for useful indoor tracking. Accordingly, it would be beneficial to have a real time tracking and positioning system capable of providing accurate, real-time positions of actors within a space or building. More specifically, it would be beneficial to have a real time tracking and positioning system capable of providing real-time positions of an actor within 20 centimeters of an actual position of the actor.

### SUMMARY OF THE DISCLOSURE

In one embodiment of the present disclosure, a real time tracking and positioning system of the present disclosure comprises at least four anchors, at least one actor configured to interact with the at least four anchors, and an electronic device in communication with at least one of the at least four anchors, wherein the electronic device is configured to receive two-way ranging/distance data for each actor based on message timing information of at least three communicated messages between the at least one actor and each anchor and calculate a real-time position of each actor based on the two-way ranging/distance data, the two-way ranging/distance data including a round-trip time of a radio frequency signal between the at least one actor and each of the at least four anchors.

In one aspect of the system, the electronic device is further configured to display the real-time position of each actor.

In another aspect of the system, the electronic device is further configured to use at least three distance measurements to calculate a position error and use the position error and the ranging/distance data to calculate the real-time position of each actor.

In a further aspect of the system, the real-time position is determined in a two-dimensional space.

In another aspect of the system, the real-time position is determined in a three-dimensional space.

In another aspect of the system, the electronic device is in communication with at least one of the at least four anchors via a USB connection.

In another aspect of the system, the calculated real-time position of the actor is within 20 centimeters of an actual position of the actor.

In a further aspect of the system, the anchors and the actors each include a transceiver.

In another aspect of the system, the transceiver is a wireless transceiver.

In another aspect of the system, the at least one actor includes a single microcontroller having an ultra-wideband chip.

In a further aspect of the system, the at least one actor includes between 8 and 10 actors.

In another aspect of the system, the two-way ranging/distance data includes a distance between the at least one actor and each of the at least four anchors, each of the distances being different.

In a further aspect of the system, the two-way ranging/distance data is based on timing information alone.

In another embodiment of the present disclosure, a method for tracking the position of an actor indoors comprises providing a real time tracking and positioning system comprising at least four anchors, at least one actor configured to interact with the at least four anchors, and an electronic device in communication with at least one of the at least one actor and at least one of the at least four anchors, transmitting a radio frequency signal between each actor and each of the at least four anchors, collecting ranging/distance data including round-trip times of the radio frequency signal transmitted between the at least one actor and each of the at least four anchors, calculating a real-time position of each actor using a trilateration algorithm, a trilateration error-correction algorithm, and the ranging/distance data, the trilateration error-correction algorithm using at least three distance measurements from the ranging/distance data; and displaying the real-time position of each actor on a monitor of the electronic device.

In one aspect of the method, the real-time position is calculated within a two-dimensional space and the trilateration error-correction algorithm uses four distance measurements.

In another aspect of the method, the real-time position is calculated within a three-dimensional space and the trilateration error-correction algorithm uses five distance measurements.

In another aspect of the method, the electronic device is in communication with at least one of the at least four anchors via a USB connection.

In a further aspect of the method, the calculated real-time position is within 20 centimeters of an actual position of the actor.

In another aspect of the method, the ranging/distance data is based on message timing information of at least three communicated messages between the at least one actor and each anchor.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The foregoing aspects and many of the intended advantages of this disclosure will become more readily appreciated as the same becomes better understood by reference to the following detailed description when taken in conjunction with the accompanying drawing.

FIG. 1 shows a schematic view of an embodiment of a real time tracking and positioning system of the present disclosure within a room;

FIG. 2 shows a schematic view of another embodiment of a real time tracking and positioning system of the present disclosure;

FIG. 3 shows a perspective view of an embodiment of an actor of the real time tracking and positioning system of FIG. 1;

FIG. 4 shows a perspective view of another embodiment of an actor of the real time tracking and positioning system of FIG. 1;

FIG. 5 shows a perspective view of an embodiment of an anchor of the real time tracking and positioning system of FIG. 1;

FIG. 6A shows a diagram characterizing a sequence of messages sent between an actor and an anchor of the real time tracking and position system of FIG. 1 used to determine two-way ranging/distance data for each actor;

FIG. 6B shows another diagram characterizing a sequence of messages sent between an actor and an anchor of the real time tracking and position system of FIG. 1 used to determine two-way ranging/distance data for each actor;

FIG. 7 shows a flow diagram characterizing the use of the real time tracking and position system of FIG. 1;

FIG. 8 shows a diagram of an actor of an embodiment of a real time tracking and position system broadcasting a POLL message;

FIG. 9 shows a diagram of anchors within range of the actor of FIG. 8 sending RESPONSE messages to the actor; and

FIG. 10 shows a diagram of the actor of FIG. 8 sending a message to the desired anchors.

Although the drawing represents an embodiment of various features and components according to the present disclosure, the drawing is not necessarily to scale and certain features may be exaggerated in order to better illustrate and explain the present disclosure. The exemplification set out herein illustrates embodiments of the disclosure, and such exemplifications are not to be construed as limiting the scope of the disclosure in any manner.

### DETAILED DESCRIPTION

For the purposes of promoting an understanding of the principals of the disclosure, reference will now be made to the embodiment illustrated in the drawing, which is described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

A real time tracking and positioning system is disclosed for determining the position of at least one actor within an indoor space in real-time. Specifically, the real time tracking and positioning system is configured to provide an accurate and precise position of at least one actor within the indoor space in real-time. The indoor space may include any indoor or covered area including areas within the same building or areas within two separate building connected by a covered area, for example rooms, hallways between rooms, or covered walkways connecting rooms or buildings alone or any combination thereof.

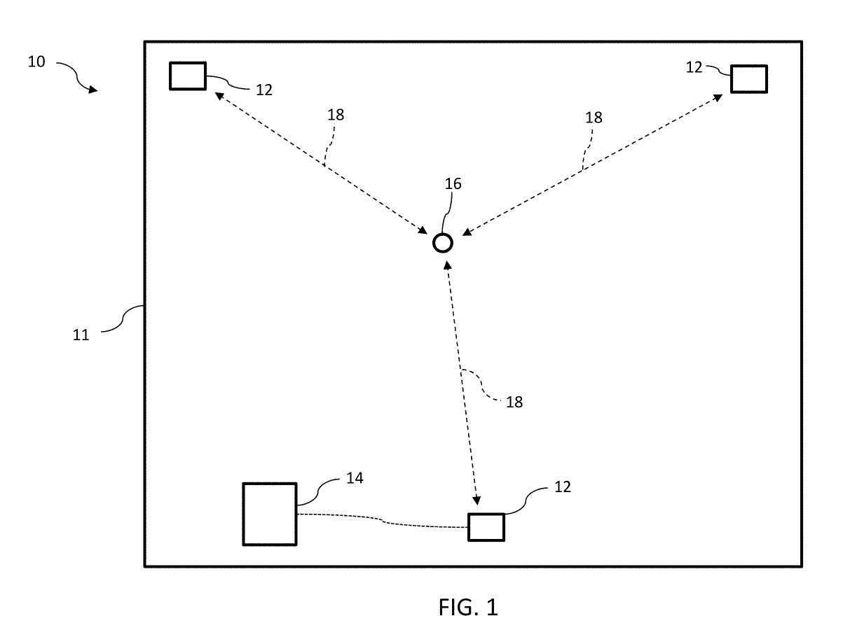

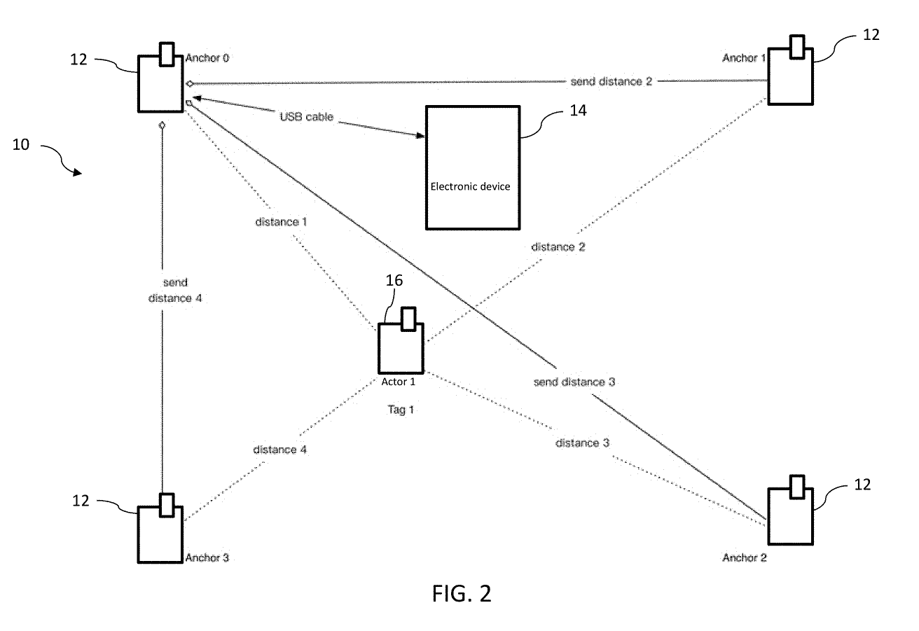

Referring to FIGS. 1 and 2, a system 10 for determining a position of an actor within an indoor space 11 generally includes a plurality of anchors 12 spaced apart within the indoor space 11, and at least one actor 16 positioned within the indoor space 11 in communication with each of the anchors 12. In various embodiments, the system 10 includes at least three anchors 12 and a plurality of actors 16 (i.e., around 20 or 30 actors or more). In an exemplary embodiment, the system 10 includes four anchors and 8-10 actors. In addition, system 10 generally includes an electronic device 14 configured to be in communication with at least one of the anchors 12 and/or the actor 16. When electronic device 14 is in communication with one of anchors 12, the positioning system is in a centralized mode, where all distance measurements for all actors 16 and anchors 12 are reported to the electronic device 14 through the anchor 12 which it is in communication with such that a position of actors 16 can be determined. On the other hand, when electronic device 14 is in communication with actor 16, the positioning system is in a decentralized mode, where distance measurements and anchor positions are provided to electronic device 14 coupled to actor 16, and device 14 computes the position of actor 16 itself. In an exemplary embodiment, the electronic device 14 is in communication with the at least one anchor 12 through a USB cable connection. In other various embodiments, the anchor 12 or actor 16 may be in communication with the electronic device 14 through a wireless connection, e.g., BLUETOOTH™ connection or wireless LAN connection.

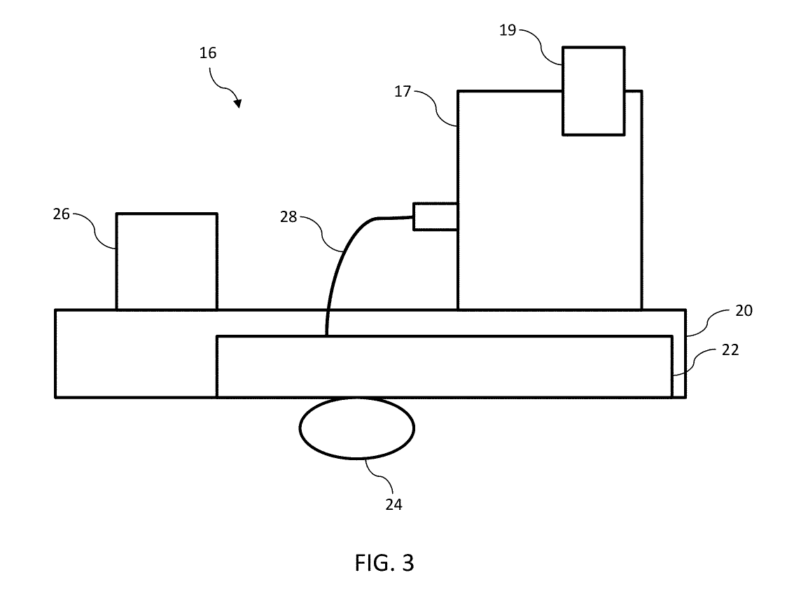

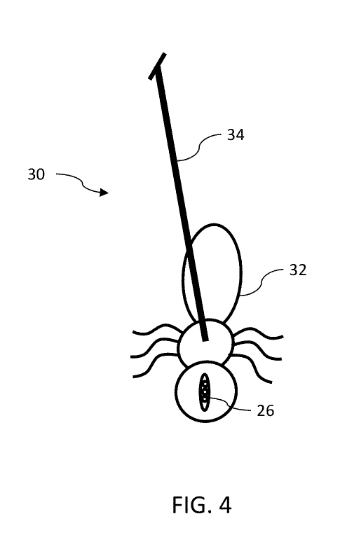

With reference to FIGS. 3 and 4, actor 16 generally refers to a two-way ranging printed circuit board 17 having a transceiver 19 that moves within the indoor space 11. In an exemplary embodiment, the transceiver 19 is a wireless transceiver (e.g., ScenSor DW1000 produced by DECAWAVE™). In various embodiments, printed circuit board 17 and transceiver 19 are a single microcontroller unit having ultra-wideband (UWB) capabilities that is configured to send and receive complex messages such as computer network frames using a UWB chip. In an exemplary embodiment, the UWB chip is a 802.15.4 compliant UWB chip.

Actor 16 may also include a frame 20 configured to support the printed circuit board 17, a battery 22 configured to power the printed circuit board 17, a wheel 24 configured to allow frame 20 and/or printed circuit board 17 to move around the indoor space 11, an LED circuit 26 configured to emit light from at least one LED light at various times, and/or an actuator configured to transmit a signal to the electronic device 14 to capture or mark the current location of the actor 16. In various embodiments, the battery 22 may be coupled to the printed circuit board 17 via a wired connection 28. The wired connection 28 may be a USB cable coupled to the battery 22 and inserted into a USB interface (not shown) on the printed circuit board 17. Furthermore, in various embodiments, LED circuit 26 may include a microchip and/or a wireless transmitter configured to transmit data from LED circuit 26 to the anchors 12 and/or the electronic device 14. In addition, the electronic device 14 may be configured to display the captured or marked location while the actor 16 is still in the marked location and even after the actor 16 has moved.

In various embodiments, actors 16 may be embedded in an apparatus (i.e., a piece of clothing, an electronic puppet, a bag, a wearable piece, etc.). However, when actor 16 is embedded in an apparatus, transceiver 19 may be accessible to open air if transceiver 19 is a wireless transceiver. In an exemplary embodiment, actors 16 may be electronic puppets 30 capable of receiving location-related feed-back on a puppet interface (see FIG. 4). Electronic puppets 30 generally include a body 32 configured to house at least some of the elements of the actor 16 and a handle 34 configured for controlling electronic puppet 30. In an exemplary embodiment, the body 32 of the electronic puppets 30 is made of silicon and shaped in the form of an ant. However, the body 32 of the electronic puppets may be formed in any shape.

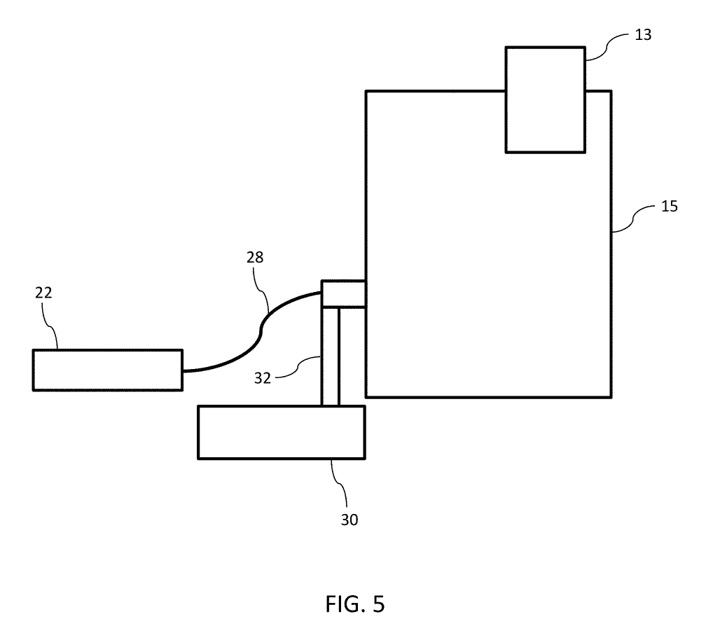

Additionally, in various embodiments, the printed circuit board 17 of actors 16 may further include a two-way ranging software (e.g., DecaRangeRTLS produced by DECAWAVE™ or a modified version thereof). Furthermore, the printed circuit board 17 may also include an off-board antenna, a USB interface, a processor, and/or an LCD display. In various embodiments, actors 16 may be connected to each other via wired or wireless connections. Referring to FIG. 5, anchors 12, on the other hand, are generally fixed objects spaced about indoor space 11, each having a transceiver 13. In an exemplary embodiment, the transceivers 13 of anchors 12 are wireless transceivers (e.g., ScenSor DW1000 produced by DECAWAVE™). Additionally, in various embodiments, anchors 12 may include two-way ranging printed circuit boards 15 including the transceiver 13 and two-way ranging software (e.g., DecaRangeRTLS produced by DECAWAVE™ or a modified version thereof). In various embodiments, the two-way ranging printed circuit board 15 of anchor 12 may be similar to the printed circuit board 13 of the actors 16. The printed circuit board 15 of anchor 12 may also include an off-board antenna, a USB interface, a processor, and/or an LCD display. Like actor 16, transceivers 13 and printed circuit boards 15 may be a single microcontroller unit having ultra-wideband (UWB) capabilities that is configured to send and receive complex messages such as computer network frames using a UWB chip.

In various embodiments, the anchor 12 may further include a battery 22 configured to power the printed circuit board 15. The battery 22 may be coupled to the printed circuit board 15 by a wired connection 28. In various embodiments, the wired connection 28 is a USB cable coupled to the battery 22 and inserted into a USB interface (not shown) on the printed circuit board 15.

In general, anchors 12 are fixed in place so that they may be used for determining a precise position of each actor 16 moving between the anchors 12. In various embodiments, the anchors 12 are supported in a fixed place by a support apparatus 30. In various embodiments, the support apparatus 30 includes an extension 32 configured to support the printed circuit board 15 of anchor 12. In an exemplary embodiment, a base of the support apparatus 30 may be a tripod or similar structure.

To determine the position of the actor 16, the anchors 12 may be configured to communicate with each other to first establish the position of each anchor 12. On the other hand, in various embodiments, the position of each anchor 12 may be manually entered into electronic device 14 once placed within indoor space 11. Furthermore, in various embodiments, actors 16 and/or anchors 12 may be powered by a USB battery or other power supply. Additionally, in various embodiments, the transceivers of the actor 16 and the anchors 12 may be substantially identical.

With reference to FIG. 1, actors 16 are generally in wireless communication with anchors 12 to produce two-way ranging/distance data that can be used to determine the actor's precise location. Ranging/distance data is generally determined using the wireless transceivers (e.g., ScenSor DW1000 produced by DECAWAVE™) of the actor 16 and the anchors 12. In general, a radio frequency signal 18 is transmitted from the transceiver of actor 16 to the transceivers of each of at least three of the anchors 12. In various embodiments, the radio frequency signals 18 transmitted from actor 16 may have an update rate of about 1 Hz to about 32 Hz. The two-way ranging/distance data generally includes round-trip times of the radio frequency signals 18 transmitted between an antenna of the transceiver of the actor 16 and an antenna of the transceivers of each of the anchors 12. In various embodiments, the timing information is in the format of IEEE 802.15.4 standard encoding for a data frame. The round-trip times of a radio frequency signal for each anchor 12 allows the system 10 to calculate a precise location of the actor 16 based on timing information alone. Signal strength of various signals, alone or in combination with timing information has proven incapable of producing sufficiently accurate and precise distance information. In various embodiments, the real-time position of each actor can be determined in a two-dimensional space (i.e., x-axis and y-axis), while in other various embodiments, the real-time position of each actor can be determined in a three-dimensional space (i.e., x-axis, y-axis, and z-axis).

Electronic device 14 is configured to receive or collect the two-way ranging/distance data between each of the actors 16 and at least three of the anchors 12. In various embodiments, the anchors 12 may be configured to communicate with each other to transmit ranging/distance data to the electronic device 14. In other various embodiments, the actor 16 may be configured to receive the ranging/distance data from each of the anchors 12 and transmit it to the electronic device 14 or to the at least one anchor 12 in communication with the electronic device 14. In an exemplary embodiment, the electronic device 14 may use a serial interface or application programming interface to receive all of the ranging/distance data between the anchors 12 and the actors 16. Electronic device 14 is also configured to calculate a real-time position for each actor 16 within the indoor space 11 based at least on the two-way ranging/distance data collected or received.

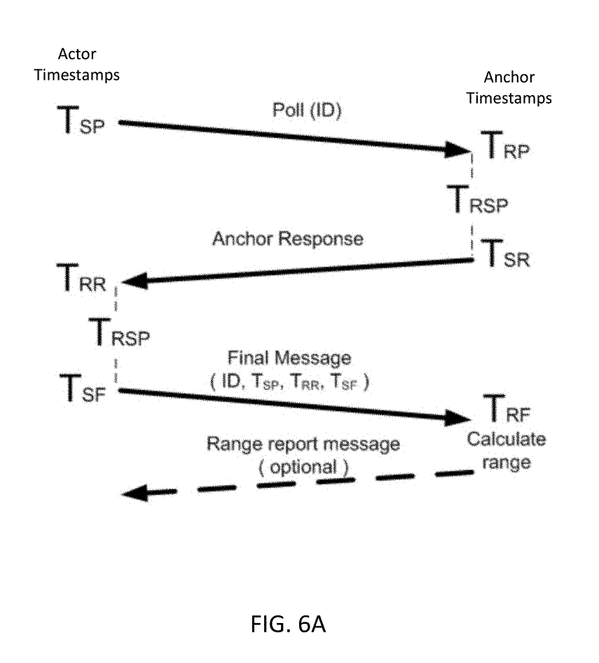

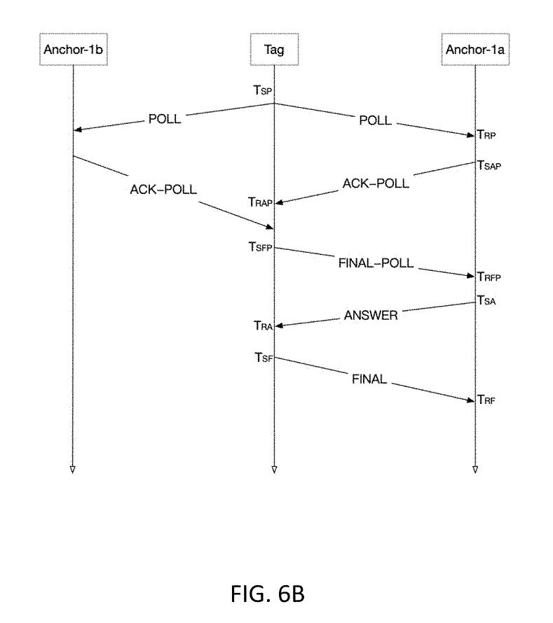

With reference to FIGS. 6A and 6B, the two-way ranging/distance data collected for calculating the real-time position for each actor 16 can be determined using a ranging algorithm. This approach uses three or more communicated messages between actor 16 and one of the anchors 12 to calculate the distance between two RF transceivers, specifically actor 16 and the specific anchor 12. For the ranging algorithm, actor 16 periodically initiates a range measurement, while anchors 12 listen and respond to actor 16 and calculate the range. More specifically, actor 16 sends a Poll message addressed to a target anchor and notes the send time, T_{SP}. Actor 16 listens for a Response message. If no response arrives after some period, actor 16 will resend the Poll message and if still no Response it will time out and go to sleep. Anchor 12 listens for a Poll message addressed to it, and when anchor 12 receives a poll it notes the receive time T_{RP}, and sends a Response message back to actor 16, noting its send time T_{SR}. When actor 16 receives the Response message, it notes the receive time T_{RR} and sets the future send time of the Final response message T_{SF}, and embeds this time in the message before initiating the delayed sending of the Final message to anchor 12. Anchor 12, receiving the Final message at time, T_{RF}, now has enough information to work out the range. The algorithm used by anchor 12 to determine the Time of Flight of the messages for the two-way ranging/distance data is (2T_{RR}−T_{SP}−2T_{SR}+T_{RP}+T_{RF}−T_{SF})/4. The range or distance is then determined using the equation (v*TOF), where v is the propagation speed of the generated signal. Once a range or distance is calculated, anchor 12 may send a ranging report of the calculated two-way ranging/distance data to actor 16 so that it may know the range as well.

In various embodiments, the algorithm used to determine the Time of Flight of the messages for the two-way ranging/distance data may include additional rounds of message exchange. For example, instead of sending its “anchor type” information in the ANSWER message, anchor 12 may reply with its “anchor type” information in a separate message, so that actor 16 can decide to stop exchanging messages with anchor 12 according to duplicated anchor type. Another example includes the transmission of a poll acknowledging message and a final poll message (see FIG. 6B), which would allow actor 16 to ignore one anchor 12 of the same type of another anchor 12 that it is exchanging messages with. Based on the additional messages, the time-of-flight calculation can be optionally performed with more rounds of timestamps for reducing the margin of error. For example, the Time of Flight algorithm can be (2T_{RAP}−T_{SP}−2T_{SAP}+T_{RP}+2T_{RFP}−2T_{SFP}+2T_{RA}−2T_{SA}+T_{RF}−T_{SF})/8 based on the message exchange shown in FIG. 6B.

In various embodiments, electronic device 14 may include a processor, and the processor may be configured with trilateration algorithms (e.g., Levenberg-Marquardt algorithm and non-linear least squares method) to convert the two-way ranging/distance data from the anchors 12 into digital signals containing a real-time position of each actor 16 capable of being displayed by device 14. The trilateration algorithm uses the ranging/distance data from at least 4 anchors 12 to determine the position of actor 16, where the distance between each of anchors 12 and actor 16 may be different. Furthermore, the processor may include algorithms configured to optimize the real-time position of each actor using a 3 or more-trilateration error-correction algorithm to determine a position error calculation. The use of 4-trilateration error-correction algorithm gives a more accurate 2D position, while the use of at least 5-trilateration error-correction algorithm gives a more accurate 3D position. The position error calculation may be used in addition to the round-trip times of the radio frequency signals 18 when calculating the real-time position of the actor 16 such that the real-time position may have an accuracy of ±50 centimeters or better. In an exemplary embodiment, the accuracy of the real-time position of an actor 16 may be as close as ±1 centimeter. Using these trilateration algorithms allows actors 16 to be outside of an area defined by anchors 12 so long as actors 16 are within communication range of anchors 12 (i.e., approximately 20 meters).

In various embodiments, electronic device 14 is further configured to display the determined real-time positions of each actor 16 on a monitor or display screen of the electronic device 14. In an exemplary embodiment, the electronic device 14 may display the real-time position of each actor 16 on an animated HTML5 web page, or other web user interface. Additionally, electronic device 14 may be configured to easily support “replay” and “on-the-fly configuration” features as well as other gaming and statistical features. Electronic device 14 may be a computer, tablet computer, mobile phone or any other device capable of communicating or connecting to at least one anchor 12. In various embodiments, electronic device 14 may include a server.

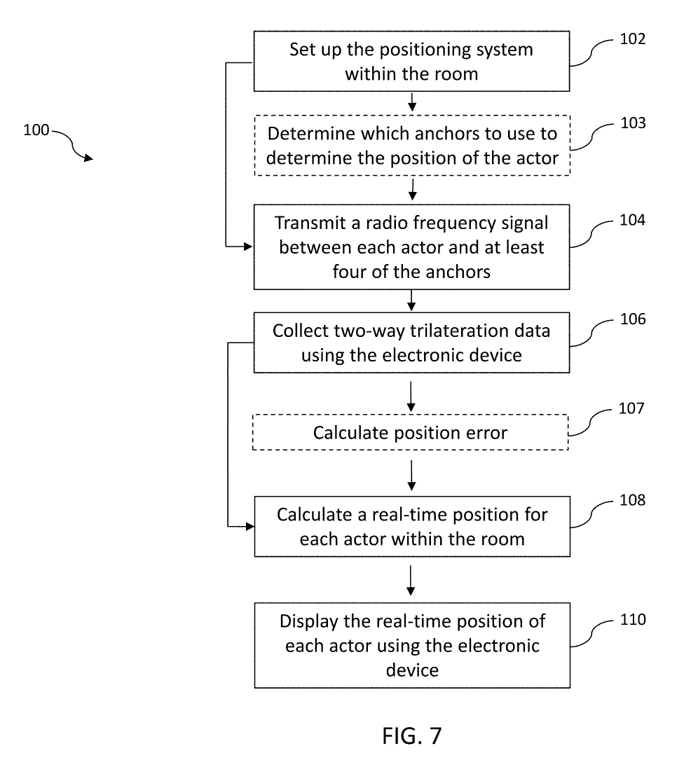

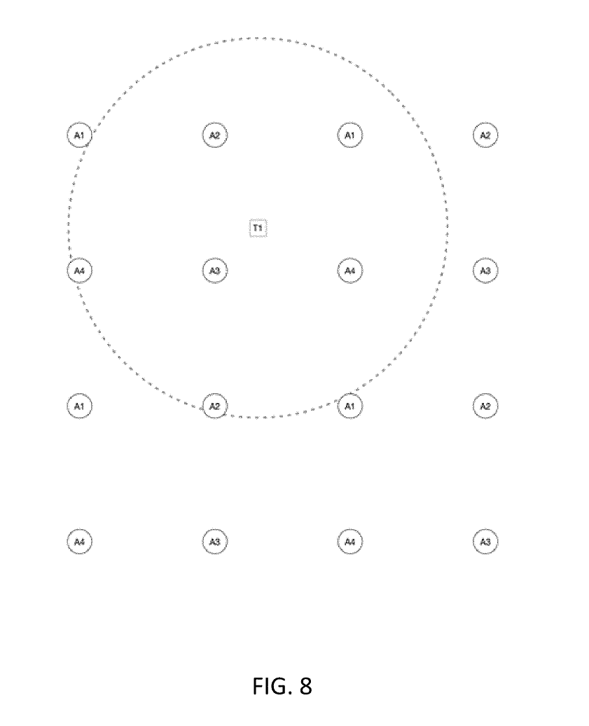

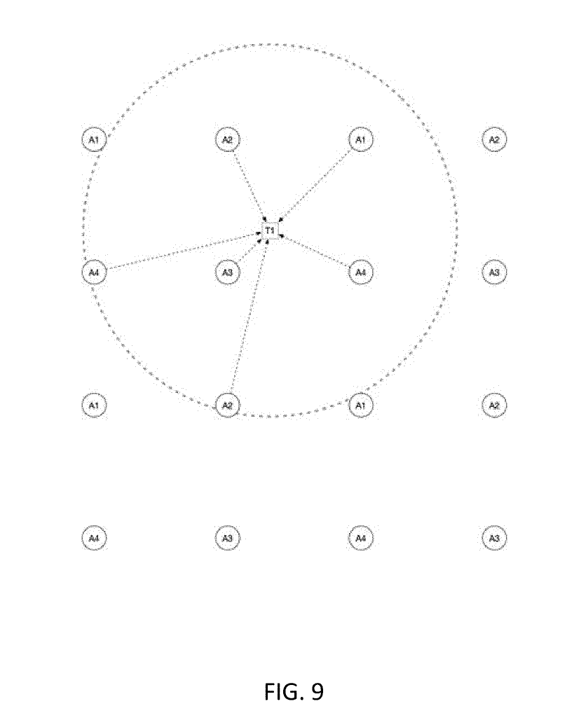

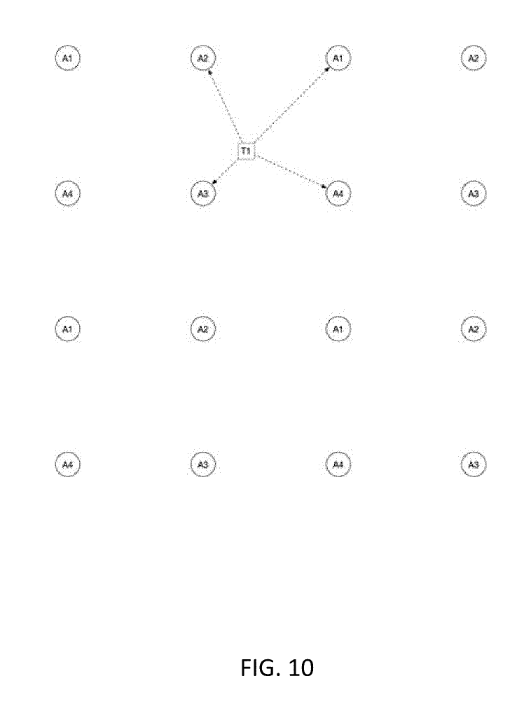

Referring now to FIG. 7, a method 100 for using system 10 is shown. First, step 102 comprises setting up system 10 within indoor space 11. The setup of system 10 may comprise positioning the at least three anchors 12 around the indoor space 11, positioning each of the actors 16 within the indoor space 11 between the anchors 12, coupling at least one of the anchors 12 to the electronic device 14, determining or establishing the position of each anchor 12, and/or powering on the actors 16, the anchors 12, and/or the electronic device 14. Step 104 comprises transmitting the radio frequency signal 18 between each actor 16 and at least four anchors 12 (see FIG. 8). Next, step 106 comprises collecting the two-way ranging/distance data, which includes the round-trip times of the radio frequency signal 18 transmitted between the at least one actor 16 and at least three anchors 12, using the electronic device 14. Step 108 comprises using trilateration algorithms (e.g., Levenberg-Marquardt algorithm and non-linear least squares method) within the electronic device 14 to calculate a real-time position of each actor 16 within the indoor space 11 based on the collected two-way ranging/distance data. Finally, step 110 comprises displaying the calculated real-time position of each actor 16 within the indoor space 11 using the electronic device 14. In various embodiments, the method 100 may also include steps 103 and/or 107. Step 103 comprises determining which anchors 12 will be used to determine the position of actor 16. To do so, actor 16 broadcasts a POLL message (see FIG. 9), and each of the anchors within transmission range of actor 16 responds with an ANSWER message (see FIG. 10). From the received ANSWER messages, actor 16 determines which anchors 12 to send signal 18. Step 107 comprises calculating a position error for each real-time position of each actor 16, and using the calculated position error along with the ranging/distance data to calculate the real-time position of each actor 16 within 20 centimeters of an actual position of the actor 16. In various embodiments step 107 may occur prior to step 108 initiating, whereby the real-time position is calculated only after both the ranging/distance data and the position error are calculated, while in other various embodiments, step 108 may reoccur and a real-time position may be recalculated after step 107, whereby a real-time position may be calculated prior to the position error being determined, and then recalculated after the position error has been calculated.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Furthermore, the scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A real time tracking and positioning system comprising:
at least four anchors positioned within an indoor space;
at least one actor configured to interact with the at least four anchors; and
an electronic device in communication with at least one of the at least one actor and at least one of the at least four anchors, wherein the electronic device is configured to receive two-way ranging/distance data for each actor based on message timing information of at least three communicated messages between the at least one actor and each anchor and calculate a real-time position of each actor based on the two-way ranging/distance data, the two-way ranging/distance data including a round-trip time of a radio frequency signal between the at least one actor and each of the at least four anchors.

2. The real time tracking and positioning system of claim 1, wherein the electronic device is further configured to display the real-time position of each actor.

3. The real time tracking and positioning system of claim 1, wherein the electronic device is further configured to use at least three distance measurements to calculate a position error and use the position error and the ranging/distance data to calculate the real-time position of each actor.

4. The real time tracking and positioning system of claim 1, wherein the real-time position is determined in a two-dimensional space.

5. The real time tracking and positioning system of claim 1, wherein the real-time position is determined in a three-dimensional space.

6. The real time tracking and positioning system of claim 1, wherein the electronic device is in communication with at least one of the at least four anchors via a USB connection.

7. The real time tracking and positioning system of claim 1, wherein the calculated real-time position of the actor is within 20 centimeters of an actual position of the actor.

8. The real time tracking and positioning system of claim 1, wherein the anchors and the actors each include a transceiver.

9. The real time tracking and positioning system of claim 8, wherein the transceiver is a wireless transceiver.

10. The real time tracking and positioning system of claim 1, wherein the at least one actor includes a single microcontroller having an ultra-wideband chip.

11. The real time tracking and positioning system of claim 1, wherein the at least one actor includes between 8 and 10 actors.

12. The real time tracking and positioning system of claim 1, wherein the two-way ranging/distance data includes a distance between the at least one actor and each of the at least four anchors, each of the distances being different.

13. The real time tracking and positioning system of claim 1, wherein the two-way ranging/distance data is based on timing information alone.

14. A method for tracking the position of an actor within an indoor space comprising the steps of:
providing a real time tracking and positioning system comprising at least four anchors, at least one actor configured to interact with the at least four anchors, and an electronic device in communication with at least one of the at least one actor and at least one of the at least four anchors, wherein the at least four anchors are spaced apart within the indoor space;
transmitting a radio frequency signal between each actor and at least four of the at least four anchors at substantially the same time;
collecting ranging/distance data including round-trip times of the radio frequency signal transmitted between the at least one actor and each of the at least four anchors;
calculating a real-time position of each actor using a trilateration algorithm, a trilateration error-correction algorithm, and the ranging/distance data, the trilateration error-correction algorithm using at least three distance measurements from the ranging/distance data; and
displaying the real-time position of each actor on a monitor of the electronic device.

15. The method of claim 14, wherein the real-time position is calculated within a two-dimensional space and the trilateration error-correction algorithm uses four distance measurements.

16. The method of claim 14, wherein the real-time position is calculated within a three-dimensional space and the trilateration error-correction algorithm uses five distance measurements.

17. The method of claim 14, wherein the electronic device is in communication with at least one of the at least four anchors via a USB connection.

18. The method of claim 14, wherein the calculated real-time position is within 20 centimeters of an actual position of the actor.

19. The method of claim 14, wherein the ranging/distance data is based on message timing information of at least three communicated messages between the at least one actor and each anchor.
